(19) United States
(12) Patent Application Publication
(10) Pub. No.: US 2025/0166861 A1
(43) Pub. Date: May 22, 2025

(54) SWITCH NETWORK ION TRAP CONTROLLER

(71) Applicant: Quantinuum, LLC, Broomfield, CO (US)

(72) Inventors: Leonardo Ascarrunz, Lafayette, CO (US); David Deen, Broomfield, CO (US); Timothy Peterson, Broomfield, CO (US); Christopher E. Langer, Broomfield, CO (US); Paul M. Werking, Charlotte, NC (US)

(21) Appl. No.: 18/828,555

(22) Filed: Sep. 9, 2024

Related U.S. Application Data
(60) Provisional application No. 63/588,494, filed on Oct. 6, 2023.

(51) Int. Cl. G21K 1/00

(52) U.S. Cl. CPC G21K 1/00

(57) ABSTRACT

A quantum object confinement apparatus is provided comprising one or more electrode sequences and a voltage control circuit for providing analog control signals to at least a first symmetric pair of control electrodes of one of the electrode sequences. The voltage control circuit (i) selectively closes one of a first plurality of switches to complete an electrical connection between the voltage control circuit and a first symmetric control electrode and (ii) simultaneously selectively closes one of a second plurality of switches to complete an electrical connection between the voltage control circuit and a second symmetric control electrode. The voltage control circuit applies a same voltage to an input of the one of the first plurality of switches and to an input of the one of the second plurality of switches prior to selectively closing and as the switches close.

### CROSS-REFERENCE TO RELATED APPLICATIONS

This application claims priority to and the benefit of U.S. Provisional Patent Application Ser. No. 63/588,494, filed Oct. 6, 2023, which is incorporated herein by reference in its entirety.

### TECHNICAL FIELD

Various embodiments relate to apparatuses, systems, and methods relating to controlling quantum objects within a quantum object confinement apparatus. For example, some example embodiments relate to the use of a switch network for voltage control in a periodic or quasi-periodic array of trapping regions of a quantum object confinement apparatus.

### BACKGROUND

Quantum charge-coupled device (QCCD)-based quantum systems have been shown to be usable for performing quantum computations with a small number of quantum objects. However, to increase the number of quantum objects confined by a confinement apparatus of a QCCD-based quantum system, the size of the confinement apparatus must also increase. Increasing the size of the confinement apparatus requires increasing the number of control electrodes of the confinement apparatus. The infrastructure for providing voltage signals to each of the control electrodes quickly becomes very large and complex. Through applied effort, ingenuity, and innovation many deficiencies of such prior confinement apparatuses and methods of operation therefore have been solved by developing solutions that are structured in accordance with the embodiments of the present invention, many examples of which are described in detail herein.

### BRIEF SUMMARY OF EXAMPLE EMBODIMENTS

Example embodiments provide quantum object confinement apparatuses, systems comprising quantum object confinement apparatuses, quantum computers comprising quantum object confinement apparatuses, and methods for controlling voltages in quantum object confinement apparatuses.

In an example embodiment, and according to an aspect of the present disclosure, a quantum object confinement apparatus comprises one or more electrode sequences and a voltage control circuit. Each electrode sequence comprises a respective plurality of control electrodes configured to control an electric potential in a respective trapping region of one or more trapping regions of the quantum object confinement apparatus. The voltage control circuit provides analog control signals to at least a first symmetric pair of the plurality of control electrodes, the first symmetric pair of the control electrodes comprising first and second symmetric control electrodes. The voltage control circuit (i) selectively closes one of a first plurality of switches to complete an electrical connection between the voltage control circuit and the first symmetric control electrode and (ii) simultaneously selectively closes one of a second plurality of switches to complete an electrical connection between the voltage control circuit and the second symmetric control electrode. The voltage control circuit applies a same voltage to an input of the one of the first plurality of switches and to an input of the one of the second plurality of switches prior to selectively closing the one of the first plurality of switches and the one of the second plurality of switches and as the one of the first plurality of switches and the one of the second plurality of switches close. The voltage control circuit selectively provides one of two or more analog control signals to the first symmetric control electrode via the one of the first plurality of switches after the one of the first plurality of switches is closed. The voltage control circuit selectively provides one of two or more analog control signals to the second symmetric control electrode the one of the second plurality of switches after the one of the second plurality of switches is closed.

In an example embodiment, the voltage control circuit comprises a first voltage control subcircuit for providing analog control signals to the first symmetric pair of the control electrodes. The first voltage control subcircuit comprises the first plurality of switches, the second plurality of switches, and first latching circuitry. Each switch of the first plurality of switches has an input connected to a respective one of a first plurality of analog inputs, an output connected to a first analog output line for connecting a selected one of the first plurality of analog inputs to the first symmetric control electrode, and a switch activation line for causing a respective switch of the first plurality of switches to close. Each switch of the second plurality of switches has an input connected to a respective one of the first plurality of analog inputs, an output connected to a second analog output line for connecting a selected one of the first plurality of analog inputs to the second symmetric control electrode, and a switch activation line for causing a respective switch of the second plurality of switches to close. The first latching circuitry has a plurality of first latch inputs comprising first and second subsets of the first latch inputs, a corresponding plurality of first latch outputs comprising first and second subsets of the first latch outputs, and a first latch enable input. Each one of the first subset of the first latch outputs is connected to a switch activation line of a respective switch of the first plurality of switches, and each one of the second subset of the first latch outputs is connected to a switch activation line of a respective switch of the second plurality of switches. Applying a voltage to the first latch enable input causes (i) a voltage applied to one of the first subset of the first latch inputs to be present on a respective one of the first subset of the first latch outputs and therefore present on a respective one of the switch activation lines of the first plurality of switches, and (ii) a voltage applied to one of the second subset of the first latch inputs to be present on a respective one of the second subset of the first latch outputs and therefore present on a respective one of the switch activation lines of the second plurality of switches, thereby causing a respective one the first plurality of switches and a respective one of the second plurality of switches to close simultaneously.

In an example embodiment, the voltage control circuit comprises a second voltage control subcircuit for providing analog control signals to a second symmetric pair of the control electrodes. The second symmetric pair of the control electrodes comprises third and fourth symmetric control electrodes. The second voltage control subcircuit comprises a third plurality of switches, a fourth plurality of switches, and second latching circuitry. Each switch of the third plurality of switches has an input connected to a respective one of a second plurality of analog inputs, an output connected to a third analog output line for connecting a selected one of the second plurality of analog inputs to the third symmetric control electrode, and a switch activation line for causing the respective switch of the third plurality of switches to close. Each switch of the fourth plurality of switches has an input connected to a respective one of the second plurality of analog inputs, an output connected to a fourth analog output line for connecting a selected one of the second plurality of analog inputs to the fourth symmetric control electrode, and a switch activation line for causing the respective switch of the fourth plurality of switches to close. The second latching circuitry has a plurality of second latch inputs comprising first and second subsets of the second latch inputs, a corresponding plurality of second latch outputs comprising first and second subsets of the second latch outputs, and a second latch enable input. Each one of the first subset of the second latch outputs is connected to a switch activation line of a respective switch of the third plurality of switches, and each one of the second subset of the second latch outputs is connected to a switch activation line of a respective switch of the fourth plurality of switches. Applying a voltage to the second latch enable input causes (i) a voltage applied to one of the first subset of the second latch inputs to be present on a respective one of the first subset of the second latch outputs and therefore present on a respective one of the switch activation lines of the third plurality of switches, and (ii) a voltage applied to one of the second subset of the second latch inputs to be present on a respective one of the second subset of the second latch outputs and therefore present on a respective one of the switch activation lines of the fourth plurality of switches, thereby causing a respective one of the third plurality of switches and a respective one of the fourth plurality of switches to close simultaneously.

In an example embodiment, the quantum object confinement apparatus further comprises one or more data input lines and an address decoder. The one or more data input lines apply a voltage to one of the first subset of first latch inputs, one of the second subset of first latch inputs, one of the first subset of second latch inputs, and/or one of the second subset of second latch inputs. The address decoder comprises a plurality of latch enable outputs including a first latch enable output connected to a first latch enable input of the first latching circuitry and a second latch enable output connected to a second latch enable input of the second latching circuitry, one or more address input lines for receiving an indication of which one or more of the plurality of latch enable outputs should be activated, and an enable input for receiving an indication to activate the one or more of the plurality of latch enable outputs indicated by the one or more address input lines.

According to another aspect of the present disclosure, a system comprises two or more switchable control voltage sources each configured to generate a respective switchable control voltage signal, a controller configured to control operation of each of the two or more switchable control voltage sources, and with which of the two or more switchable control voltage sources one or more switchable control electrodes are respectively in electrical communication, and a quantum object confinement apparatus. The quantum object confinement apparatus comprises one or more electrode sequences and a voltage control circuit. Each electrode sequence comprises a respective plurality of control electrodes configured to control an electric potential in a respective trapping region of one or more trapping regions of the quantum object confinement apparatus. The voltage control circuit provides analog control signals to at least a first symmetric pair of the plurality of control electrodes, the first symmetric pair of the control electrodes comprising first and second symmetric control electrodes. The voltage control circuit (i) selectively closes one of a first plurality of switches to complete an electrical connection between the voltage control circuit and the first symmetric control electrode and (ii) simultaneously selectively closes one of a second plurality of switches to complete an electrical connection between the voltage control circuit and the second symmetric control electrode. The voltage control circuit applies a same voltage to an input of the one of the first plurality of switches and to an input of the one of the second plurality of switches prior to selectively closing the one of the first plurality of switches and the one of the second plurality of switches and as the one of the first plurality of switches and the one of the second plurality of switches close. The voltage control circuit selectively provides one of two or more analog control signals to the first symmetric control electrode via the one of the first plurality of switches after the one of the first plurality of switches is closed. The voltage control circuit selectively provides one of two or more analog control signals to the second symmetric control electrode the one of the second plurality of switches after the one of the second plurality of switches is closed.

According to another aspect of the present disclosure, a quantum computer comprises two or more switchable control voltage sources each configured to generate a respective switchable control voltage signal, a controller configured to control operation of each of the two or more switchable control voltage sources, and with which of the two or more switchable control voltage sources one or more switchable control electrodes are respectively in electrical communication, and a quantum object confinement apparatus. The quantum object confinement apparatus comprises one or more electrode sequences and a voltage control circuit. Each electrode sequence comprises a respective plurality of control electrodes configured to control an electric potential in a respective trapping region of one or more trapping regions of the quantum object confinement apparatus. The voltage control circuit provides analog control signals to at least a first symmetric pair of the plurality of control electrodes, the first symmetric pair of the control electrodes comprising first and second symmetric control electrodes. The voltage control circuit (i) selectively closes one of a first plurality of switches to complete an electrical connection between the voltage control circuit and the first symmetric control electrode and (ii) simultaneously selectively closes one of a second plurality of switches to complete an electrical connection between the voltage control circuit and the second symmetric control electrode. The voltage control circuit applies a same voltage to an input of the one of the first plurality of switches and to an input of the one of the second plurality of switches prior to selectively closing the one of the first plurality of switches and the one of the second plurality of switches and as the one of the first plurality of switches and the one of the second plurality of switches close. The voltage control circuit selectively provides one of two or more analog control signals to the first symmetric control electrode via the one of the first plurality of switches after the one of the first plurality of switches is closed. The voltage control circuit selectively provides one of two or more analog control signals to the second symmetric control electrode the one of the second plurality of switches after the one of the second plurality of switches is closed.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising a quantum system controller according to an example embodiment.

FIG. 2 provides a schematic diagram of an example quantum system controller of a quantum computer.

FIG. 3 provides a schematic diagram of an example computing entity of a quantum computer system that may be used in accordance with an example embodiment.

FIG. 4A provides a top view of at least a portion of an example quantum object confinement apparatus that may be used in an example embodiment.

FIG. 4B provides a schematic diagram of the electrode sequences corresponding to two linear trapping regions, in accordance with an example embodiment.

FIG. 5 provides a schematic diagram of a switch network for voltage control on symmetric pairs of control electrodes, in accordance with an example embodiment.

FIG. 6 provides a schematic diagram of a switch assembly, in accordance with an example embodiment.

FIG. 7 provides a schematic diagram of a switch network for voltage control on shim electrodes, in accordance with an example embodiment.

FIG. 8 provides a schematic diagram of a switch network for voltage control on shim electrodes, in accordance with another example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide systems, apparatuses, methods, computer program products, and/or the like for a switch network for voltage control. For example, various embodiments provide systems, apparatuses, methods, computer program products, and/or the like for the design and use of a switch network for voltage control for use in a quantum object confinement apparatus of a quantum computing system.

Various embodiments provide and/or provide methods for use with various confinement apparatuses. For example, the confinement apparatus may be an optical trap, magnetic trap, dipole trap, quadrupole trap, and/or the like comprising a plurality of trapping regions of similar and/or a common structure. The confinement apparatus is configured to confine a respective type of quantum object (e.g., neutral atom/molecule, charged/ionic atom/molecule, quantum particle, quantum dot, and/or the like). One or more trapping regions of the confinement apparatus comprises respective switchable control elements that are switchably in communication with two or more switchable control signals provided by respective switchable confinement control field sources. The ability to select between the two or more switchable control signals enables the performance of conditional operations within the respective trapping regions. Various embodiments for performance of conditional operations are described in pending U.S. Provisional Patent Application Ser. No. 63/481,665, filed Jan. 26, 2023, titled CONDITIONAL OPERATIONS IN QUANTUM OBJECT CONFINEMENT APPARATUS USING BROADCASTED CONTROL VOLTAGE SIGNALS, the contents of which is incorporated herein in its entirety.

In embodiments related to quantum computers, the ion trap architectures of an example quantum computer may possess electrode quantities in excess of several thousand, which may include gridded regions for various ion transport operations. These ion trap architectures may use an interconnect paradigm requiring a wire bond and a physical feedthrough signal line allocated for every individual electrode. In such embodiments, in order to meet the requirement for this scale of electrodes, an integrated switching network serves to distribute the necessary waveforms for ion transport and to condense the interconnections that are integrated into the trap, and such an integrated switching network may use one or more of high-voltage semiconductor switches.

In various embodiments, such a high-voltage semiconductor switch serves as a single-pole single-throw semiconductor-based switch with an enable line serving as the throw control. Various embodiments of such a high-voltage semiconductor switch are described in pending U.S. Provisional Patent Application Ser. No. 63/586,214, filed Sep. 28, 2023, titled HIGH-VOLTAGE GLITCH-SUPPRESSED SEMICONDUCTOR SWITCH FOR QUANTUM OBJECT CONFINEMENT APPARATUS, the contents of which is incorporated herein in its entirety.

In various embodiments using high-voltage semiconductor switches, switch-related noise must be mitigated. Switch noise in semiconductor-based switches arises due to several factors. Two switch-related noise sources are charge injection from capacitive imbalance between the load and pass transistors and during specific on/off transitions of the switch when one switch is not entirely turned off when another switch turns on. The former has been referred to as “switch glitch” and occurs when excess charge, due to the imbalanced capacitance between load and transistor gate, is deposited on the load during an on/off transition. The result is an incrementally small excess voltage over the intended level present at the load. This excess voltage may be allowed to build through successive switch cycles as the capacitance imbalance continues to allow excess charge to be transferred. A voltage glitch can also come from clock feedthrough.

Such excess voltage from switch glitch can produce an electric field that can cause a quantum object to be “pushed” in an unintended and undesired direction. Various embodiments of the present disclosure provide a switch network which provides voltage control to a quantum object confinement apparatus and which minimizes glitch. In various embodiments, a voltage control circuit provides analog control signals to one or more symmetric pairs of control electrodes.

In various embodiments, such a voltage control circuit closes a switch to complete an electrical connection between the voltage control circuit and a first control electrode of a symmetric pair of control electrodes and simultaneously closes another switch to complete an electrical connection between the voltage control circuit and a second control electrode of the symmetric pair of control electrodes. In various embodiments, the voltage control circuit ensures that the same voltage is present on the inputs of these two switches when the two switches are simultaneously closed. In various embodiments, each switch is one of a corresponding plurality of switches. In various embodiments, the switches of the pluralities of switches are of a same type and design.

By using the same type and design of switches and by ensuring that the same voltage is present on the inputs of these two switches when the two switches are simultaneously closed, it is likely that any glitch produced by each of the two simultaneously closed switches will have the same magnitude or nearly so. By simultaneously closing the two switches, the glitches produced by the two simultaneously closed switches will reach each of the two control electrodes of the symmetric pair and the “pushing” effect on each side of a quantum object therebetween will likely cancel out.

In various embodiments, each switch is one of a corresponding plurality of switches such that, after the switches are closed, the voltage control circuit can supply one of a plurality of different control signals to each of the control electrodes of the symmetric pair.

In various embodiments, the voltage control circuit comprises two or more voltage control subcircuits, each of which provides voltage control to a corresponding symmetric pair of control electrodes. In various embodiments, one or more voltage control subcircuits provide voltage control to corresponding symmetric pairs of control electrodes aligned along a first axis (e.g., an X axis), while one or more voltage control subcircuits provide voltage control to corresponding symmetric pairs of control electrodes aligned along a second axis (e.g., a Y axis) perpendicular to the first axis.

In various embodiments, each voltage control subcircuit comprises two pluralities of switches (which may be termed switch arrays). In various embodiments, the switches in each switch array are arranged such that the input of each switch is connected to a respective one of a plurality of analog inputs and the output of each switch is connected to the same analog output line for connecting a selected one of the plurality of analog inputs to a corresponding one of the control electrodes of the pair of symmetric control electrode. In various embodiments, each switch in each switch array has a switch activation line for causing the corresponding switch to close.

In various embodiments, each of the two switch arrays in each of voltage control subcircuit is connected to the same plurality of analog inputs. In various embodiments, each analog input is connected to one switch in one of the two switch arrays and to one switch in the other of the two switch arrays. In various embodiments, each switch array comprises a plurality of single pole, single throw switches wired in parallel on one side. In various embodiments, each switch array comprises four switches, with the input of each switch being connected to a different one of four analog inputs to provide one of four different analog signals to each of electrode of the symmetric pair of control electrodes. Having four different analog signal to choose from, instead of fewer, mitigates crosstalk issues between the two electrodes.

In various embodiments, only one of the switches of each switch array is closed at the same time during performance of conditional operations. In various embodiments, loopback testing of the voltage control subcircuit is performed by closing two switches in at least one of the switch arrays at the same time, with one closed switch conducting its associated analog signal and the other closed switch receiving the analog signal from the first closed switch such that the analog signal can be verified. In various embodiments, by changing which two switches are closed, it is possible to verify all of the analog signals.

In various embodiments, each voltage control subcircuit comprises latching circuitry (also termed a latch). In various embodiments, each latch has eight inputs (in two subsets of four each) and eight outputs (in two subsets of four each). In various embodiments, each of the latch outputs in each subset is connected to a corresponding switch activation line of a corresponding switch in a corresponding switch array. In various embodiments, each of the latch inputs in each subset corresponds to a latch output in a corresponding subset, and therefore each of the latch inputs in each subset corresponds to a switch activation line of a corresponding switch. In various embodiments, the latch inputs receive signals to indicate which corresponding switch should be closed to provide the corresponding analog input to the corresponding control electrode of the symmetric pair. Because only one of the switches of each switch array is closed at the same time during performance of conditional operations, in various embodiments only one latch input of each subset receives a signal to cause only one switch of each switch array to close during performance of conditional operations.

In various embodiments, each latch comprises a latch activation line. In various embodiments, when the latch activation line of a latch receives a signal, the two signals on the latch inputs (one on each subset) are then output on the corresponding latch outputs to the corresponding switch activation lines, thereby causing the two corresponding switches to close simultaneously.

In various embodiments, some of the voltage control subcircuits provide voltage control to corresponding symmetric pairs of control electrodes aligned along a first axis (e.g., an X axis), while one or more voltage control subcircuits provide voltage control to corresponding symmetric pairs of control electrodes aligned along a second axis (e.g., a Y axis) perpendicular to the first axis.

In various embodiments, the voltage control subcircuits that provide voltage control to corresponding symmetric pairs of control electrodes aligned along a first axis are all connected to different analog inputs than are the voltage control subcircuits that provide voltage control to corresponding symmetric pairs of control electrodes aligned along a second axis. This allows for compensation of x-y crosstalk in the analog waveforms.

In various embodiments, all of the voltage control subcircuits that provide voltage control to corresponding symmetric pairs of control electrodes aligned along a first axis are all connected to the same first plurality of analog inputs, while all of the voltage control subcircuits that provide voltage control to corresponding symmetric pairs of control electrodes aligned along a second axis are all connected to the same second plurality of analog inputs.

In various embodiments, the voltage control circuit comprises a data bus, such as an 8-bit data bus, that provides the inputs to the latches of the voltage control subcircuits.

In various embodiments, the address decoder comprises a plurality of latch enable outputs. In various embodiments, each of the latch enable outputs is connected to a latch activation line of a corresponding latch.

In various embodiments, the address decoder comprises one or more address input lines. In various embodiments, the address that is input to the one or more address input lines specifies which of the plurality of latch enable outputs is/are activated. In various embodiments, the address decoder comprises an enable input which causes an output on the latch enable output(s) specified by the address input line(s).

In various embodiments, the switch network of embodiments of the present disclosure may be incorporated into an application specific integrated circuit (ASIC).

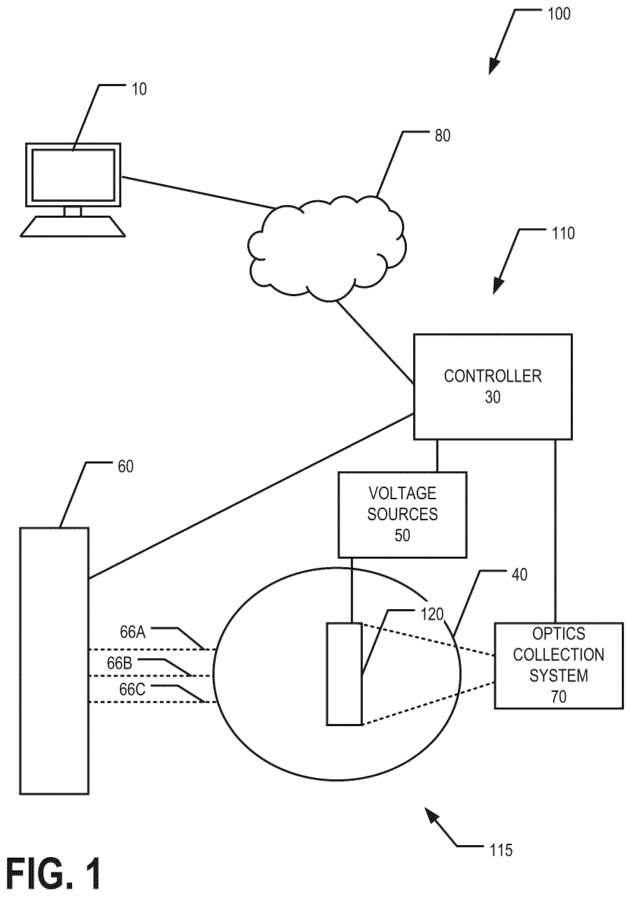

In various embodiments, a network of high-voltage semiconductor switches may be used in a quantum computing system, such as the quantum computing system 100 depicted in FIG. 1. FIG. 1 provides a schematic diagram of an example quantum computing system 100 where the quantum processor comprises an atomic object confinement apparatus 120 (e.g., an ion trap and/or the like) having a plurality of atomic objects (e.g., atoms, ions, and/or the like) confined therein, in accordance with an example embodiment. In various embodiments, the quantum computing system 100 comprises a computing entity 10 and a quantum computer 110. In various embodiments, the quantum computer 110 comprises a quantum system controller 30 and a quantum processor 115. In various embodiments, the quantum system controller 30 is configured, programmed, and/or the like to control the quantum processor 115. In an example embodiment, the quantum processor 115 comprises a plurality of qubits (e.g., data qubits that may be organized into logical qubits, ancilla qubits, and/or the like). In various embodiments, the quantum computer 110 includes or communicates with databases (not shown) described herein. For example, the databases may be stored by one or more computing entities 10 that are in communication with the controller 30 via one or more wired and/or wireless networks 80 and/or stored by memory local to the controller 30.

In various embodiments, the quantum processor 115 comprises means for controlling the evolution of quantum states of the qubits. For example, in an example embodiment, the quantum processor 115 comprises a cryostat and/or vacuum chamber 40 enclosing a confinement apparatus 120 (e.g., an ion trap), one or more manipulation sources 60, one or more voltage sources 50, and/or one or more optics collection systems 70. For example, the cryostat and/or vacuum chamber 40 may be a temperature and/or pressure-controlled chamber. In an example embodiment, the manipulation signals generated by the manipulation sources 60 are provided to the interior of the cryostat and/or vacuum chamber 40 (where the atomic object confinement apparatus 120 is located) via corresponding optical paths 66 (e.g., 66A, 66B, 66C). In an example embodiment, the one or more manipulation sources 60 may comprise one or more lasers (e.g., optical lasers, microwave sources, and/or the like). In various embodiments, the one or more manipulation sources 60 are configured to manipulate and/or cause a controlled quantum state evolution of one or more atomic objects within the confinement apparatus. In various embodiments, the atomic objects within the atomic confinement apparatus (e.g., ions trapped within an ion trap) act as the data qubits and/or ancilla qubits of the quantum processor 115 of the quantum computer 110. For example, in an example embodiment, wherein the one or more manipulation sources 60 comprise one or more lasers, the lasers may provide one or more laser beams to atomic objects trapped within the confinement apparatus 120 within the cryostat and/or vacuum chamber 40. For example, the manipulation sources 60 may generate and/or provide laser beams configured to ionize atomic objects, initialize atomic objects within the defined two state qubit space of the quantum processor, perform gates one or more qubits of the quantum processor, read a quantum state of one or more qubits of the quantum processor, and/or the like.

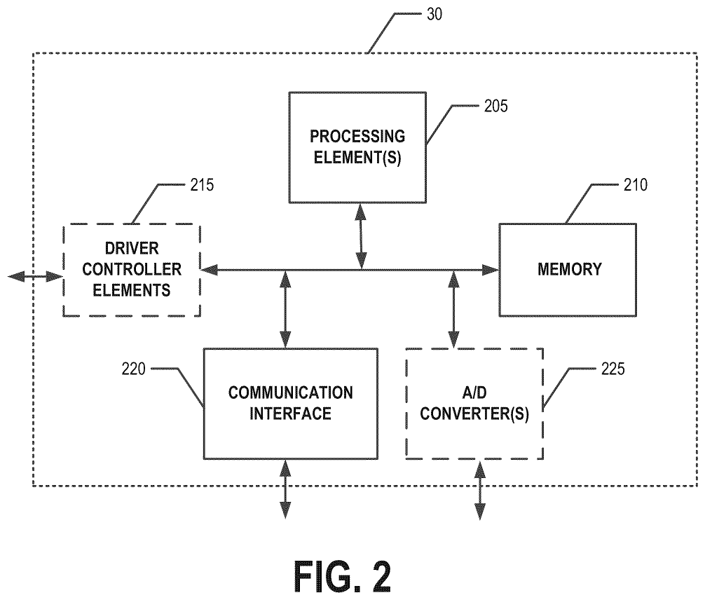

In various embodiments, the quantum computer 110 comprises an optics collection system 70 configured to collect and/or detect photons generated by qubits (e.g., during reading procedures). The optics collection system 70 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer 110. In various embodiments, the detectors may be in electronic communication with the quantum system controller 30 via one or more A/D converters 225 (see FIG. 2) and/or the like.

In various embodiments, the quantum computer 110 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 120, in an example embodiment. Varying the electrical potential(s) may move the ions between locations or states. In various embodiments, how to vary the electrical potential(s) may be defined by waveforms that specify one or more voltages to apply over a period of time. In various embodiments, the one or more voltage source 50 may be coupled to electrodes via circuitry including one or more high-voltage semiconductor switches. The circuitry coupling the voltage sources 50 to the electrodes may also include circuitry providing bias voltages, such as to a gate of one or more FETs in one or more of the high-voltage semiconductor switches. The circuity coupling the voltage sources 50 the electrodes may also include circuitry connecting one or more voltage sources to the gates and/or drains of the one or more FETs in one or more of the high-voltage semiconductor switches. In various embodiments, the circuity coupling the voltage sources 50 the electrodes may be located outside the cryostat and/or vacuum chamber 40, inside the cryostat and/or vacuum chamber 40, or both inside and outside the cryostat and/or vacuum chamber 40. In embodiments where the circuitry coupling the voltage sources 50 to the electrodes is located in the cryostat and/or vacuum chamber 40, the high-voltage semiconductor switch may be located in the cryostat and/or vacuum chamber 40. In various embodiments the circuity coupling the voltage sources 50 to the electrodes, including the one or more high-voltage semiconductor switches, will be comprised of circuit components capable of and/or configured to operate at the temperatures for their location, such as those in the cryostat and/or vacuum chamber, which may have temperatures below 4 Kelvin.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the quantum system controller 30 of the quantum computer 110 via one or more wired or wireless networks 80 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the quantum system controller 30 can understand and/or implement. For example, the controller 30 is configured to generate machine code level commands configured to, when executed by the appropriate components of the quantum computer 110, cause the performance of a quantum circuit by the quantum computer 110. In various embodiments, the performance of a quantum circuit may include providing and/or controlling voltages to one or more terminals of a high-voltage semiconductor switch, which may control how the high-voltage semiconductor switch provides voltage to one or more electrodes.

In various embodiments, the quantum system controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, and/or the like) within the cryostat and/or vacuum chamber 40 and/or configured to manipulate and/or cause a controlled evolution of quantum states of one or more atomic objects within the confinement apparatus. For example, the quantum system controller 30 may cause a controlled evolution of quantum states of one or more atomic objects within the confinement apparatus to execute a quantum circuit and/or algorithm. For example, the quantum system controller 30 may cause a reading procedure comprising coherent shelving to be performed, possibly as part of executing a quantum circuit and/or algorithm. Additionally, the quantum system controller 30 is configured to communicate and/or receive input data from the optics collection system 70 and corresponding to the reading of the quantum state of qubits of the quantum computer 110. In various embodiments, the atomic objects confined within the confinement apparatus are used as qubits of the quantum computer 110.

In various embodiments, a quantum computer 110 comprises a quantum system controller 30 and a quantum processor 115. The quantum system controller 30 is configured to control various components of a quantum processor 115.

In various embodiments, the quantum system controller 30 is in communication with an optics collection system 70 such that the quantum system controller 30 is configured to receive input data captured and/or generated by the optics collection system 70. In various embodiments, the quantum system controller 30 is further configured to control a cryostat system and/or vacuum system controlling the temperature and pressure within the cryostat and/or vacuum chamber 40, cooling system, and/or other systems controlling the environmental conditions (e.g., temperature, humidity, pressure, and/or the like) within the cryostat and/or vacuum chamber 40.

As shown in FIG. 2, in various embodiments, the quantum system controller 30 may comprise various quantum system controller elements including processing element(s) 205, memory 210, driver controller elements 215, a communication interface 220, analog-digital (A/D) converter(s) 225, and/or the like. In various embodiments, the quantum system controller 30 is configured to receive input data generated by the optics collection system via the A/D converter(s) 225. In various embodiments, the processing element(s) 205 are configured to operate as described herein.

In various embodiments, the processing element(s) 205 comprise processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing elements and/or circuitry, and/or the like. The term circuitry may refer to an entirely hardware embodiment or a combination of hardware and computer program products. In an example embodiment, a processing element 205 of the quantum system controller 30 comprises a clock and/or is in communication with a clock.

In various embodiments, the memory 210 comprises non-transitory memory such as volatile and/or non-volatile memory storage such as one or more of hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 210 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized quantum system controller language(s), and/or the like), and/or the like. In an example embodiment, execution of at least a portion of the computer program code stored in the memory 210 (e.g., by a processing element 205) causes the quantum system controller 30 to perform one or more steps, operations, processes, procedures, and/or the like for generating one or more sets of commands configured to cause the quantum processor 115 to perform at least a portion of a quantum circuit; to update one or more qubit registries; and/or the like. In an example embodiment, execution of at least a portion of the computer program code stored in the memory 210 causes the quantum system controller 30 to cause one or more commands to be performed.

In various embodiments, the driver controller elements 215 include one or more drivers and/or quantum system controller elements each configured to control one or more drivers. In various embodiments, the driver controller elements 215 may comprise drivers and/or driver controllers. For example, the driver controllers may be configured to cause one or more corresponding drivers to be operated in accordance with executable instructions, commands, and/or the like generated, scheduled. and executed by the quantum system controller 30. For example, the processing element 205 may generate one or more commands to be performed by a first driver.

In various embodiments, the driver controller elements 215 enable the quantum system controller 30 to operate voltage sources 50, manipulation sources 60, cooling system, vacuum systems, and/or the like. In various embodiments, the drivers may be drivers for controlling the flow of current and/or voltage applied to electrodes (e.g., configured to operate and/or control one or more voltage sources 50) used for maintaining and/or controlling the trapping potential of the confinement apparatus 120 (and/or other drivers for providing driver action sequences to potential generating elements of the confinement apparatus); laser drivers (e.g., configured to operate and/or control one or more manipulation sources 60); vacuum component drivers; cryostat and/or vacuum system component drivers; cooling system drivers, and/or the like.

In various embodiments where the drivers control the flow of current and/or voltage applied to electrodes, the driver controller elements 215 may control the high-voltage semiconductor switch. For example, control of the high-voltage semiconductor switch may be by controlling the voltage applied to one or more of the FETs, including controlling the differences in voltage(s) applied to the gate, source, and/or drain of a FET. In various embodiments, the control of voltage(s) may be through additional circuits connected to the high-voltage semiconductor switch (not depicted in the figures) such as a switching network, an example of which is described in U.S. application Ser. No. 17/305,201, filed Jul. 1, 2021, titled ION TRAP APPARATUS WITH INTEGRATED SWITCHING APPARATUS, the contents of which is hereby incorporated by reference in its entirety.

In various embodiments, each of driver controller elements 215 correspond to an endpoint within the system (e.g., a component of a manipulation source 60, a component of a voltage source 50 (radio frequency voltage sources, arbitrary waveform generators (AWG), direct digital synthesizer (DDS), and/or other waveform generator), a component of a cooling and/or vacuum system, a component of the optics collection system 70, and/or the like). Each endpoint within the quantum computer 110 represents an individual hardware control. Each endpoint may have its own set of accepted micro-commands, in various embodiments. Examples include but are not limited to a voltage source 50 such as a direct digital synthesizer (DDS), component of an optics collection system 70 such as a photomultiplier tube (PMT), a component of a manipulation source 60 such as a laser driver and/or optical modulator switch, and/or general-purpose output (GPO). Individual commands for a DDS allow for setting power level, frequency and phase of a controlling signal generated thereby. Commands for a PMT interface include start/stop photon count and reset of count, in various embodiments. Commands for a GPO endpoint include setting and/or clearing one or more output lines. These output lines can be used to control external hardware in a manner synchronized with the execution of a quantum circuit.

In various embodiments, the quantum system controller 30 comprises means for communicating and/or receiving signals from one or more optical receiver components (e.g., of the optics collection system 70). For example, the quantum system controller 30 may comprise one or more analog-digital (A/D) converter(s) 225 configured to receive signals from one or more optical receiver components (e.g., a photodetector of the optics collection system 70), calibration sensors, and/or the like. In various embodiments, the A/D converter(s) 225 are configured to write the input data generated by converting the received signals generated by one or more optical receiver components of the optics collection system 70 to memory 210.

In various embodiments, the quantum system controller 30 may comprise a communication interface 220 for interfacing and/or communicating with, for example, a computing entity 10. For example, the quantum system controller 30 may comprise a communication interface 220 for receiving executable instructions, command sets, and/or the like from the computing entity 10 and providing output received from the quantum computer 110 (e.g., from an optics collection system 70) and/or the result of a processing the output to the computing entity 10. In various embodiments, the computing entity 10 and the quantum system controller 30 may communicate via a direct wired and/or wireless connection and/or via one or more wired and/or wireless networks 80.

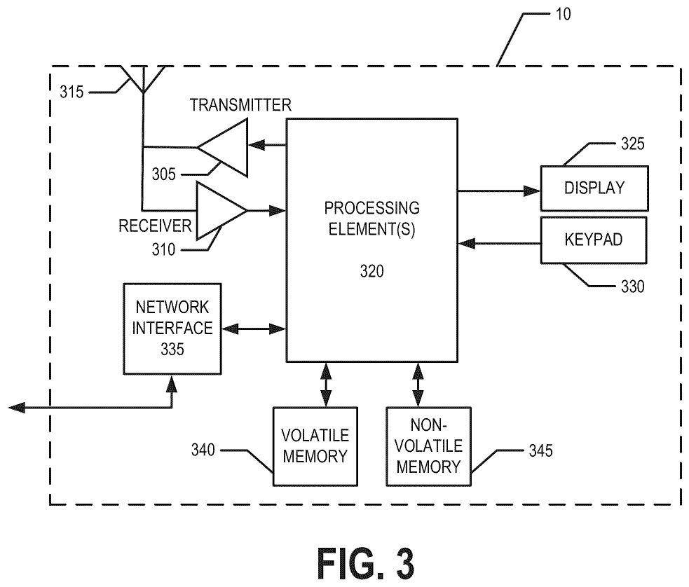

FIG. 3 provides an illustrative schematic representative of an example computing entity 10 that can be used in conjunction with embodiments of the present disclosure. In various embodiments, a computing entity 10 is a classical (e.g., semiconductor-based) computer configured to allow a user to provide input to the quantum computer 110 (e.g., via a user interface of the computing entity 10) and receive, display, analyze, and/or the like output from the quantum computer 110. In various embodiments, a user may use computing entity 10 to provide input to the quantum computer 110 that may directly or indirectly control one or more high-voltage semiconductor switches, such as when a user may provide input that results in a quantum circuit being created and/or executed, which may require a high-voltage semiconductor switch to be enabled or disable (e.g., turned ON or OFF). For example, in various embodiments, a high-voltage semiconductor switch controls the application of voltage (e.g., by a voltage source 50) to an electrode of ion trap used as part of a quantum processor 115. As should be understood, various embodiments of high-voltage semiconductor switches may be used in a variety of other applications.

As shown in FIG. 3, a computing entity 10 can include an antenna 315, a transmitter 305 (e.g., radio), a receiver 310 (e.g., radio), and a processing element 320 that provides signals to and receives signals from the transmitter 305 and receiver 310, respectively. The signals provided to and received from the transmitter 305 and the receiver 310, respectively, may include signaling information/data in accordance with an air interface standard of applicable wireless systems to communicate with various entities, such as a quantum system controller 30, other computing entities 10, and/or the like. The computing entity 10 can include a network interface 335, which may provide signals to and receive signals in accordance with an interface standard of applicable network systems to communicate with various entities, such as a quantum system controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 325 and/or speaker/speaker driver coupled to a processing element 320 and a touch screen, keyboard, mouse, and/or microphone coupled to a processing element 320). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 330 (hard or soft), a touch display, voice/speech or motion interfaces, scanners, readers, or other input device. In embodiments including a keypad 330, the keypad 330 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 340 and/or non-volatile storage or memory 345, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

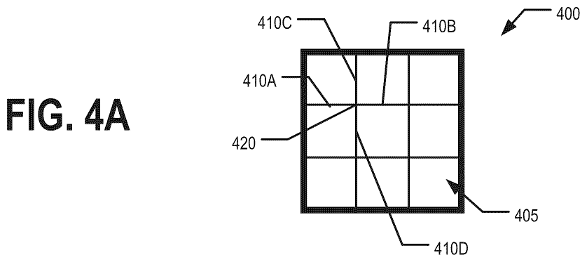

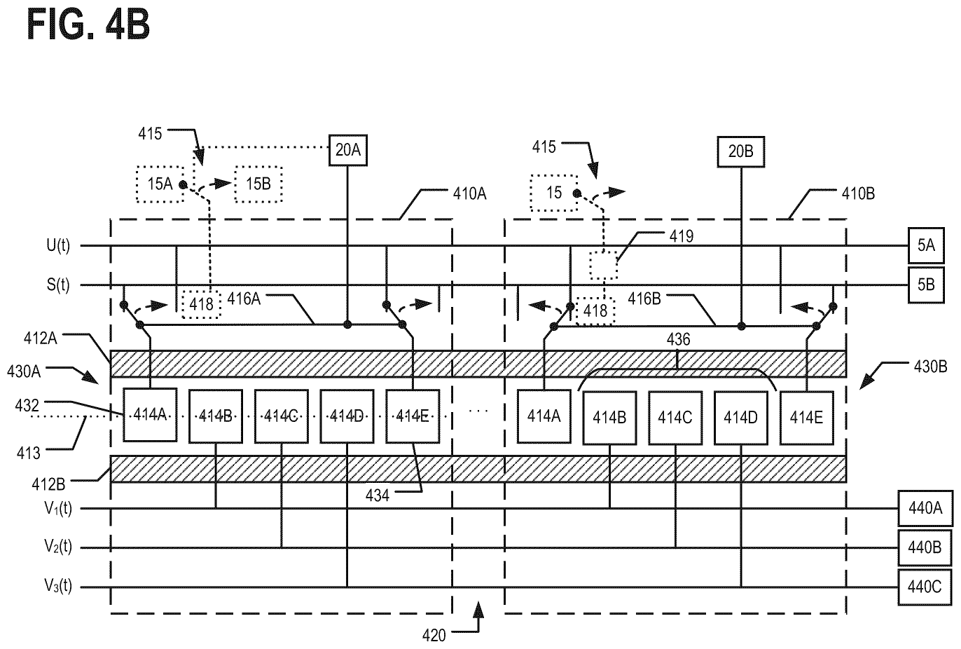

FIG. 4A provides a schematic diagram of an example confinement apparatus 400 that comprises a plurality of one-dimensional trapping regions 410 (e.g., 410A, 410B, 410C, 410D). The respective trapping regions 410 are connected to other trapping regions of the confinement apparatus 400 via junctions 420. For example, trapping regions 410A, 410B, 410C, 410D are connected to one another via junction 420. As used herein, the trapping regions 410A, 410B, 410C, and 410D are connected to another via junction 420 in the sense that one or more quantum objects disposed in trapping region 410A may be transported to any of trapping regions 410B, 410C, or 410D via the junction 420. In the illustrated embodiment, the trapping regions are arranged and/or configured to provide a periodic or quasi-periodic array 405 of trapping regions 410.

FIG. 4B provides a schematic diagram of trapping regions 410A and 410B. In various embodiments, the confinement apparatus 400 comprises one or more radio frequency (RF) electrodes, referred to as RF rails 412 (e.g., 412A, 412B) herein. A periodic voltage signal (e.g., having radio frequency periodicity) is applied to the RF rail(s) 412 to generate a confining or trapping pseudopotential that generally defines the one-dimensional trapping regions 410.

The electric potential along the axis 413 of the trapping region 410 is controlled by an electrode sequence 430 (e.g., 430A, 430B). In various embodiments, an electrode sequence 430 comprises a respective plurality of control electrodes 414 (e.g., 414A, 414B, 414C, 414D, 414E).

In various embodiments, each control electrode 414 is in communication with a respective control voltage source (via wires, leads, traces, and/or the like) such that a time varying direction current (DC) control voltage signal generated by the respective control voltage source is applied to the respective control electrode 414. In various embodiments, the control voltage signals provided to each of the plurality of control electrodes of an electrode sequence 430 is configured to define an electric potential well within the respective trapping region 410 corresponding to the electrode sequence 430. As used herein, an electrode sequence 430A corresponds to trapping region 410A when the electrode sequence 430A is configured to control the electric potential in the trapping region 410A. The control voltage signal may be varied over time to cause one or more electric potential wells to move along the one-dimensional trapping region. When two electric potential wells are present, the electric potential wells may be moved in the same or different directions along the one-dimensional trapping region 410 based on the control voltage signals applied to the electrodes 414 of the electrode sequence 430.

As should be understood, FIG. 4B illustrates one example control electrode configuration. Various other embodiments may include more or fewer than five control electrodes 414 in each sequence of control electrodes 430. In various embodiments, an electrode sequence of control electrodes 414 may include control electrodes 414 disposed outside of the RF rails 412 and/or between the RF rails 412. In an example embodiment, an electrode sequence may include one or more control electrodes that are neither switchable control electrodes nor broadcast control electrodes.

It should be understood that FIG. 4A illustrates one example of a periodic or quasi-periodic array of trapping regions. Various other embodiments include a plurality of trapping regions that each have a common structure (e.g., are defined by respective electrode sequences that are substantially the same), having zero or more broadcast electrodes and one or more switchable control electrodes, which may or may not be interconnected by junctions and may or may not have periodic or quasi-periodic array form.

The plurality of control electrodes 414 of an electrode sequence 430 comprises a first switchable control electrode 432 and a second switchable control electrode 434. The first switchable control electrode 432 and the second switchable control electrode 434 are configured to be switchably and/or alternately connected into electrical communication with one of a first switchable control voltage source 5A and a second switchable control voltage source 5B via a control switch 416 (e.g., 416A, 416B). The first switchable control voltage source 5A is configured to generate and provide a first switchable control voltage signal U(t). In various embodiments, the first switchable control voltage signal U(t) is a dynamic analog voltage signal. The second switchable control voltage source 5B is configured to generate and provide a second switchable control voltage source S(t). In various embodiments, the second switchable control voltage signal S(t) is a dynamic analog voltage signal.

As illustrated, control switch 416B is in a first switch position where the first switchable control electrode 432 is in electrical communication with a first switchable control voltage source 5A and the second switchable control electrode 434 is in electrical communication with a second switchable control voltage source 5B. Control switch 416A in a second switch position where the first switchable control electrode 432 is in electrical communication with the second switchable control voltage source 5B and the second switchable control electrode 434 is in electrical communication with the first switchable control voltage source 5A.

In an example embodiment, the control switch 416 is a double-pole double-throw switch. Other forms of switches may be used in various other embodiments, as appropriate for the application.

In various embodiments, the control switch 416 of a respective trapping region 410 is independently operable and/or controllable. As used herein, independently controllable means that the state or output of an element is independent of the state or output of each of the other like elements of the confinement apparatus. For example, the switch position of a first control switch 416A is configured to be independent of the switch position of all the other switches 416 of the confinement apparatus 400.

In various embodiments, the control switch 416 is controlled by a switch signal. For example, the switch is in electrical communication with a switch signal generator 20 (e.g., 20A, 20B). In an example embodiment, the switch signal generator is a digital signal generator. For example, in the illustrated embodiment, the switch signal is a single bit digital signal (e.g., either a first voltage representing “0” or a second voltage representing “1”). For example, when the switch signal is a first voltage, the switch is switched to and/or maintained in a first switch position and when the switch signal is a second voltage, the switch is switched to and/or maintained in a second switch position. Switching or changing the switch position changes with which of the first and second switchable control voltage sources 5A, 5B the first and second switchable control electrodes 432, 434 are in electrical communication.

In an example embodiment, the first switchable control electrode 432 is always in electrical communication with an opposite one of the first switchable control voltage source 5A and the second switchable control voltage source 5B with respect to the second switchable control electrode 434. In an example embodiment, the first switchable control electrode 432 is always in electrical communication with a same one of the first switchable control voltage source 5A and the second switchable control voltage source 5B with respect to the second switchable control electrode 434 For example, the switchable electrical communication between the first switchable control electrode 432 and the first and second switchable control voltage sources 5A, 5B and the switchable electrical communication between the second switchable control electrode 434 and the first and second switchable control voltage sources 5A, 5B is controlled by a single control switch 416. For example, switching which of the first and second switchable control voltage sources 5A, 5B that the first switchable control electrode 432 is in electrical communication with also changes which of the first and second switchable control voltage sources 5A, 5B that the second switchable control electrode 434 is in electrical communication with.

In various embodiments, the control switch 416 may define more than two switch positions. For example, in an example embodiment, a control switch 416 is switchable among two or more switch positions and each respective switch position of the two or more switch positions is configured to cause the first switchable control electrode to be in electrical communication with a selected one of two or more selectable control voltage. In various embodiments, more than two control electrodes 414 are in communication with a control switch 416. In various embodiments, a trapping region 410 may be associated with more than one control switch 416. For example, a control switch 416 may be configured to enable switchable control of placing the first switchable control electrode 432 and the second switchable control electrode 434 into electrical communication with more than two switchable control voltage sources. In another example, a second switch of a trapping region 410 may be configured to enable switchable control of placing a third switchable control electrode and a fourth switchable control electrode each into electrical communication with a respective selected one of a third switchable control voltage source and a fourth switchable control voltage source. For example, in various embodiments, N switchable control voltage sources are switchably and/or alternately in electrical communication with M control electrodes 414 of each trapping region 410 of the periodic or quasi-periodic array 405 and/or plurality of trapping regions 410 of the confinement apparatus 400, where N and M are integers greater than zero.

As illustrated in FIG. 4B, the first switchable control voltage source 5A and the second switchable control voltage source 5B are in electrical communication with respective electrodes 414 of both the trapping region 410A and the trapping region 410B. In various embodiments, the first switchable control voltage source 5A and the second switchable control voltage source 5B are in electrical communication with respective control electrodes 414 of each trapping region 410 of the periodic or quasi-periodic array 405 and/or plurality of trapping regions 410 of the confinement apparatus 400. In other words, in various embodiments, the number of switchable control voltage sources 5A, 5B does not scale with the number of trapping regions 410 of the confinement apparatus 400. For example, a quantum computing system comprising a confinement apparatus comprising 400 trapping regions may include the same number of switchable control voltage sources as a quantum computing system comprising a confinement apparatus comprising 10,000 trapping regions. However, the switchable electrical connection between the respective switchable control electrodes and the respective switchable control voltage sources 5A, 5B enable conditional performance of operations in each of the trapping regions 410.

In various embodiments, the plurality of control electrodes 414 of an electrode sequence 430 comprises one or more broadcast control electrodes 436. In various embodiments, each broadcast control electrode 436 is configured to be in electrical communication with a respective one of one or more broadcast control voltage sources 440 (e.g., 440A, 440B, 440C). In various embodiment, each broadcast control voltage source 440 is configured to generate and provide a respective broadcast control voltage signal V(t) (e.g., V₁(t), V₂(t), V₃(t)). In various embodiments, the broadcast control voltage signals are analog voltage signals.

In various embodiments, the electrical communication between a broadcast control electrode 436 and the respective broadcast control voltage source 440 is stable, consistent, and/or not changing throughout the operation of a quantum computing system comprising the confinement apparatus 400 comprising the broadcast control electrode 436. For example, the control electrode 414B of trapping region 410A and the control electrode 414B of trapping region 410B are always in electrical communication with a first broadcast control voltage source 440A throughout operation of a quantum computing system comprising the confinement apparatus 120 and the first broadcast control voltage source 440A.

As illustrated in FIG. 4B, the broadcast control voltage sources 440 are in electrical communication with respective broadcast control electrodes 436 of both the trapping region 410A and the trapping region 410B. The broadcast control voltage sources 440 are referred to as “broadcast” herein due to the voltage signals generated by the broadcast control voltage signals being provided to a plurality of respective broadcast control electrodes 436 of respective trapping regions. In various embodiments, the broadcast control voltage sources 440 are in electrical communication with respective broadcast control electrodes 436 of each trapping region 410 of the periodic or quasi-periodic array 405 and/or plurality of trapping regions 410 of the confinement apparatus 400. In other words, in various embodiments, the number of broadcast control voltage sources 5 does not scale with the number of trapping regions 410 of the confinement apparatus 400. For example, a quantum system comprising a confinement apparatus comprising 400 trapping regions may include the same number of broadcast control voltage sources as a quantum computing system comprising a confinement apparatus comprising 10,000 trapping regions (given that both confinement apparatuses have the same number of control electrodes and/or broadcast control electrodes per electrode sequence).

In various embodiments, the broadcast control voltage sources 440 are in electrical communication with respective broadcast control electrodes 436 of each trapping region 410 of the periodic or quasi-periodic array 405 and/or plurality of trapping regions 410 of the confinement apparatus 400. Thus, the electric potential generated by a first electrode sequence 430A is the same as the electric potential generated by a second electrode sequence 430B when the first control switch 416A coupled to the first electrode sequence 430A and the second control switch 416B coupled to the second electrode sequence 430B are in the same switch position. However, the electric potential generated by a first electrode sequence 430A is different from the electric potential generated by a second electrode sequence 430B when the first control switch 416A coupled to the first electrode sequence 430A and the second control switch 416B coupled to the second electrode sequence 430B are in different switch positions. Thus, in an example embodiment, a conditional operation may be performed in each trapping region 410 having the corresponding control switch 416 in a first switch position and the performance of the conditional operation is prevented in each trapping region 410 having the corresponding control switch 416 in a second switch position.

In various embodiments, the plurality of trapping regions 410 are divided into groups. For example, for the periodic or quasi-periodic array 405, the trapping regions 410 may be divided into a group of horizontal trapping regions, including trapping regions 410A and 410B, and a group of vertical trapping regions, including trapping regions 410C and 410D. In an example embodiment, a set of broadcast control voltage sources 440 is provided for each group of trapping regions. For example, trapping regions 410A and 410B comprise broadcast control electrodes 436 that are each in electrical communication with a respective broadcast control voltage source of a first set of broadcast control voltage sources and trapping regions 410C and 410D comprise broadcast control electrodes 436 that are each in electrical communication with a respective broadcast control voltage source of a second set of broadcast control voltage sources. For example, this enables independent control of operations performed in “vertical” trapping regions and operations performed in “horizontal” trapping regions while the number of voltage sources required does not scale with the number of trapping regions in the plurality of trapping regions.

In various embodiments, the trapping regions 410 are divided into groups based on sub-arrays of the confinement apparatus 400. In various embodiments, the plurality of trapping regions 410 are divided into groups based on dimensions and/or directions of the period or quasi-periodic array 405. For example, if the periodic or quasi-periodic array 405 of trapping regions 410 is a two-dimensional array, the trapping regions 410 may be divided into two groups where each group represents one of the dimensions of the array (e.g., horizontal and vertical in the example provided above). If the periodic or quasi-periodic array 405 is a three-dimensional array, the trapping regions 410 may be divided into three groups where each group represents one of the dimensions of the array, for example. In various embodiments, the trapping regions 410 may be divided into a number of groups based on factors other than the dimension of the trapping apparatus. For example, groups may be designated for certain operational purposes such as gating, initialization, measurement, loading, storage, cooling, or other functions necessary for the operation of the quantum computing system.

In an example embodiment, the plurality of broadcast control voltage sources 440 comprise a first set of broadcast control voltage sources and a second set of broadcast control voltage sources. The plurality of broadcast control electrodes of a given electrode sequence are selectively in electrical communication with respective broadcast control voltage sources of the first set of broadcast sources or the second set of broadcast sources so as to reduce crosstalk between sequences of electrodes of the plurality of sequences of electrodes. For example, in an example embodiment, the determination of whether the broadcast control electrodes of a given electrode sequence are in electrical communication with respective broadcast control voltage sources of the first of broadcast control voltage sources or the second set of broadcast control voltage sources is determined based on the whether the switch position of one or more adjacent electrode sequences is the same or a different switch position as the given electrode sequence.

In another example embodiment, the switchable control voltage sources comprise more than two switchable control voltage sources that are each configured to generate and provide a respective switchable control voltage signal. The control switches 416 are configured to enable switching electrical communication of the first and second switchable control electrodes 432, 434 among the more than two switchable control voltage sources. For example, the controller 30 may determine whether to place the first and second switchable control electrodes 432, 434 of a respective electrode sequence in electrical communication with respective ones of a first switchable control voltage source and a second switchable control voltage source or with respective ones of a third switchable control voltage source and a fourth switchable control voltage source based at least in part on the assigned switch positions of adjacent trapping regions so as to reduce any possible cross-talk between trapping regions.

The respective switchable electrical communication between the first switchable control electrode 432 and the second switchable control electrode 434 with the first switchable control voltage source 5A and the second switchable control voltage source 5B enables a conditional motion primitive that can be individually controlled in each of the trapping regions 410 via respective switches 416 even though respective broadcast control electrodes 436 of a plurality of trapping regions are each in electrical communication with the same respective broadcast control voltage sources 440.

In some embodiments, an electrode sequence 430 comprises one or more shim electrodes 418. The shim electrodes 418 are in electrical communication with a set of shim voltage sources 15. In various embodiments, stray fields in the confinement apparatus 400 may cause some motion operations in some trapping regions to be unreliable. To compensate for the stray fields, one or more quasi-static analog voltage signals are applied to one or more shim electrodes 418, in an example embodiment.

Trapping region 410B as illustrated in FIG. 4B illustrates a shim electrode 418 that is in electrical communication with a capacitor 419 that is selectively in electrical communication with a shim voltage source 15 via a shim switch 415. For example, in an example embodiment, the shim electrode voltages may be written by a shim voltage source 15 through a shim switch 415 and stored on a capacitor 419 in electrical communication with the shim electrode 418 upon which the shim voltage source is disconnected from the shim electrode (e.g., the switch is opened), leaving the capacitor 419, which is in constant electrical communication with the shim electrode, to hold the voltage value. Periodically, the shim electrode voltage is refreshed by writing it again by closing the switch to electrically connect the shim voltage source to the shim electrode and associated capacitor storage. In an example embodiment, the shim voltage periodically applied to the shim electrode may be substantially the same or substantially different than the previous value. In this way, the shim voltage value may maintain the necessary value to compensate for stray field drift and overcome slow voltage drift of the capacitor storage due to leakage currents. In another example embodiment, the shim voltage may change to effectuate different operational results. For example, the shim value may be written for gating purposes to a different value than the value used for measurement purposes.

In another example embodiment, a voltage adder is used to insert a quasi-static voltage signal onto one or more of the control electrodes 414. In an example embodiment, a shim electrode 418 is one of the control electrodes 414. As used herein, the term quasi-static refers to an analog signal that changes more slowly in time than the control voltage signals (e.g., U(t), S(t), V₁(t), V₂(t), V₃(t)). For example, the quasi-static voltage signals may have a slower update and/or a lower frequency filter cut-off than the control voltage signals.

In various embodiments, the shim electrode 418 is in switchable electrical communication with one of a first shim voltage source 15A and a second shim voltage source 15B. In various embodiments, the first shim voltage source 15A is configured to generate and provide a first shim voltage signal and the second shim voltage source 15B is configured to generate and provide a second shim voltage signal. In an example embodiment, the first shim voltage signal and the second shim voltage signal are different voltage signals having different amplitudes and/or signs. In various embodiments, the first shim voltage signal is the same amplitude and the opposite sign of the second shim voltage signal. For example, in an example embodiment, the first shim voltage signal is equal to the second shim voltage signal multiplied by negative one.

In various embodiments, the shim electrode 418 is in switchable electrical communication one of a first shim voltage source 15A and a second shim voltage source 15B via a shim switch 415. In various embodiments, the shim switch 415 is controlled via application of switch signal thereto. In an example embodiment, the switch signal applied to the shim switch 415 is the same as that applied to the control switch 416. For example, the shim switch 415 is in electrical communication with the switch signal generator 20, in an example embodiment.

In various embodiments, the same control signals are provided to the respective control electrodes 414 of a plurality of electrode sequences 430 which each corresponding to a respective trapping region 410 of a plurality of trapping regions (e.g., of a periodic or quasi-periodic array of trapping regions). The use of shim switch 415 and/or control switch 416 enables individual control of the respective trapping regions 410. For example, the switch position of the shim switch 415 and/or control switch 416 of a respective trapping region determines whether an operation is performed in the respective trapping region or prevented from being performed in the respective trapping region. In other words, the confinement apparatus 400 is configured for conditional performance of parallel operations.

In an example embodiment, different respective positions along respective trapping regions are configured for the performance of various operations thereat. For example, a first position of each respective trapping region of a plurality of trapping regions may be configured for performing a reading operation. For example, a reading manipulation signal path may be aligned with the first position of each respective trapping region of a plurality of trapping regions. Therefore, when a quantum object is located at the first position of a trapping region and a reading operation is performed (e.g., a reading manipulation signal is propagated along the reading manipulation signal path in order to determine the quantum state of the quantum object) the reading operation is performed on the quantum object. When the quantum object is not located at the first position of the trapping region when the reading manipulation signal is propagated along the reading manipulation signal path, performance of the reading operation on the quantum object is prevented.

A second position of each respective trapping region of the plurality of trapping regions may be associated with a conditional operation such as a single qubit gate, a two qubit gate, a qubit initialization operation (e.g., preparing quantum objects into a known state of a defined qubit space), position swapping of quantum objects located within the same trapping region, or another transport or non-transport operation. Using the shim switch 415 or control switch 416 of each respective trapping region of the plurality of trapping regions, whether one or more quantum objects are present at the second position or not can be controlled independently for each respective trapping region. Thus, the conditional operation is performed in a first subset of the plurality of trapping regions and is prevented from being performed (e.g., by an absence of one or more quantum objects at the second position) in a second subset of the plurality of trapping regions. For example, for an example scenario, each of the trapping regions of the plurality of trapping regions where the corresponding shim switch 415 or control switch 416 is in the first switch position is in the first subset of trapping regions and each of the trapping regions of the plurality of trapping regions where the corresponding shim switch 415 or control switch 416 is in the second switch position is the second subset of trapping regions.

In this manner, conditional operations may be performed by the confinement apparatus 400 and/or a quantum computing system comprising the confinement apparatus 400. In various embodiments, the conditional operations include one or more of a junction swap operation, a linear swap operation, a partial row or column shift, arbitrary quantum object sorting, gating of one or more quantum objects, cooling of quantum objects, measurement of quantum objects, initialization of quantum objects, position swapping of quantum objects located within a same trapping region, or another transport or non-transport operation. For example, the controller 30 may determine to perform an operation on first set of quantum objects that are arbitrarily positioned within the plurality of trapping regions and/or periodic or quasi-periodic array 405 of trapping regions and to prevent performance of the operation on a second set of quantum objects that are arbitrarily positioned within the plurality of trapping regions and/or periodic or quasi-periodic array 405 of trapping regions, even when the quantum computing system 100 is particularly configured for the parallel performance of operations.

In various embodiments, the trapping regions 410 are used for performing a conditional motion primitive. Such embodiments are described in pending U.S. Provisional Patent Application Ser. No. 63/379,040, filed Oct. 11, 2022, titled CONDITIONAL OPERATIONS IN QUANTUM OBJECT CONFINEMENT APPARATUS USING BROADCASTED CONTROL VOLTAGE SIGNALS, the contents of which is hereby incorporated by reference in its entirety.

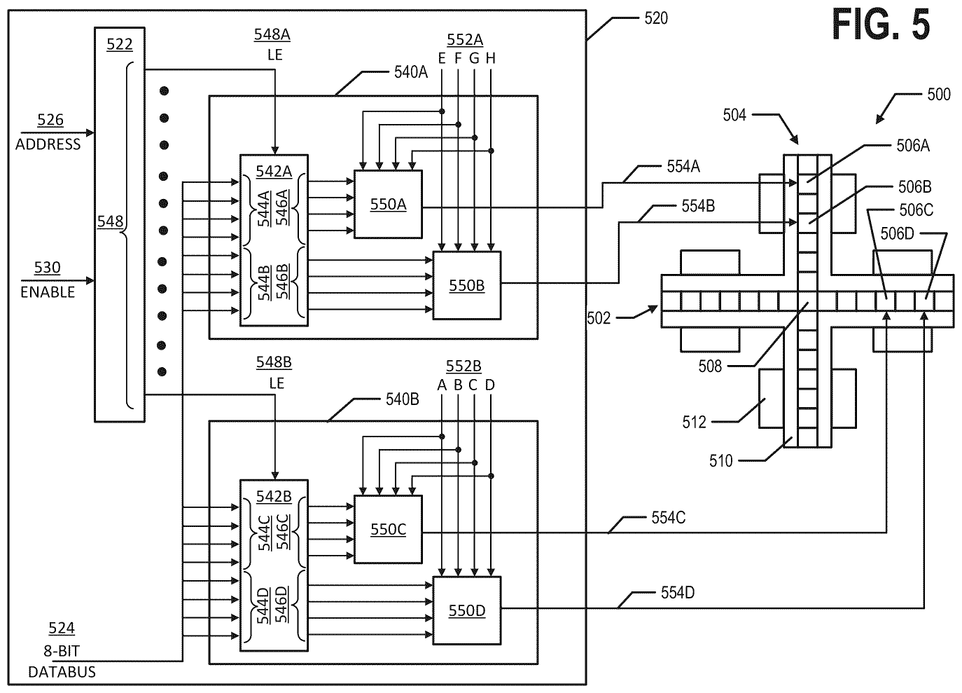

Referring now to FIG. 5, a schematic diagram of a switch network is illustrated that may be used in accordance with an example embodiment. According to various embodiments, FIG. 5 illustrates a voltage control system 520 that provides voltage control to a quantum object confinement apparatus 500. The quantum object confinement apparatus 500 comprises a plurality of control electrodes 502 aligned along an x-axis and a plurality of control electrodes 504 aligned along a y-axis, with a junction 508 where the plurality of control electrodes 502 and the plurality of control electrodes 504 meet. RF bus electrodes 510 are disposed about at least a portion of a perimeter zone of the atomic object confinement apparatus. To compensate for the stray fields, one or more quasi-static analog voltage signals are applied to one or more shim electrodes 512. In the illustrated example of FIG. 5, the plurality of control electrodes 504 aligned along a y-axis comprises two symmetric control electrodes 506A, 506B and the plurality of control electrodes 502 aligned along an x-axis comprises two symmetric control electrodes 506C, 506D.

The voltage control system 520 comprises an address decoder 522, an 8-bit data bus 524, a first voltage control subcircuit 540A, and a second voltage control subcircuit 540B. The address decoder 522 comprises one or more address input lines 526, an enable input 530, and a plurality of latch enable outputs 548 (e.g., 548A, 548B). In various embodiments, each latch enable output of the address decoder will be connected to the latch of a corresponding voltage control subcircuit.

The first voltage control subcircuit 540A comprises a first switch array 550A and a second switch array 550B. The switches in each of the first and second switch arrays 550A, 550B are arranged such that the input of each switch is connected to a respective one of a plurality of analog inputs 552A (separately labeled E, F, G H). The switches in the first switch array 550A are arranged such that the output of each switch is connected to the same first analog output line 554A for connecting a selected one of the plurality of analog inputs 552A to a first control electrode 506A of a symmetric pair of control electrodes. The switches in the second switch array 550B are arranged such that the output of each switch is connected to the same first analog output line 554B for connecting a selected one of the plurality of analog inputs 552A to a second control electrode 506B of a symmetric pair of control electrodes. Each of the switches in the first and second switch arrays 550A, 550B has a switch activation line for causing the corresponding switch to close.

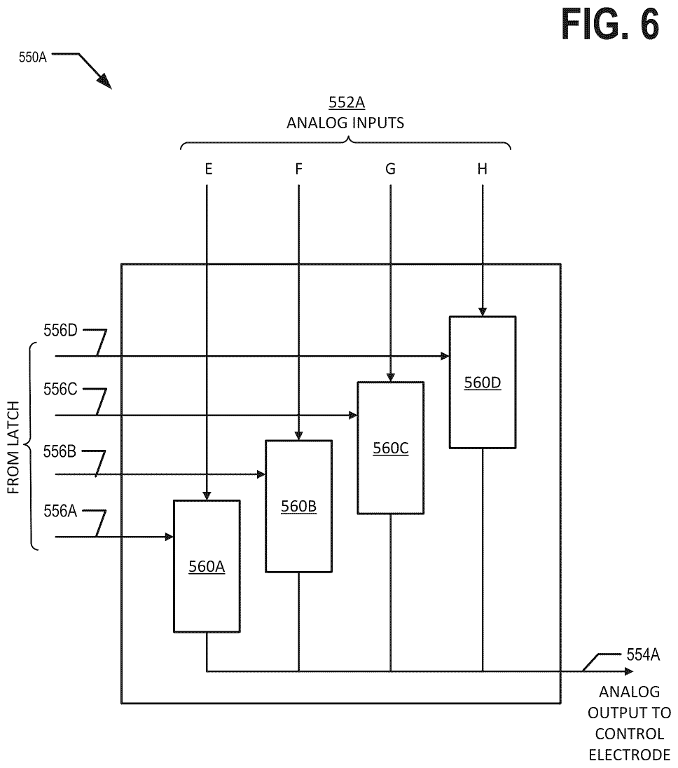

Referring now to FIG. 6, the first switch array 550A is illustrated in more detail. As seen in FIG. 6, the first switch array 550A comprises four switches 560A-D, each having an input connected to a respective one of the analog inputs 552A, each having an output connected to the same first analog output line 554A, and each having a respective switch activation line 556A-D.

Returning to FIG. 5, the first voltage control subcircuit 540A comprises a first latch 542A. The first latch 542A has eight inputs and eight outputs. The eight inputs comprise a first subset 544A and a second subset 544B, and the eight outputs comprise a first subset 546A and a second subset 546B. The first latch 542A has a latch enable line 548A.

Four of the bits from the 8-bit data bus 524 are connected to corresponding ones of the first subset 544A of first latch inputs, and the other four of the bits from the 8-bit data bus 524 are connected to corresponding ones of the second subset 544B of first latch inputs.

Each of the first subset 546A of first latch outputs is connected to a corresponding switch activation line of a corresponding switch in the first switch array 550A, and each of the second subset 546B of first latch outputs is connected to a corresponding switch activation line of a corresponding switch in the second switch array 550B.

The second voltage control subcircuit 540B comprises a third switch array 550C and a fourth switch array 550D. The switches in each of the third and fourth switch arrays 550C, 550D are arranged such that the input of each switch is connected to a respective one of a plurality of analog inputs 552B (separately labeled A, B, C, D). The switches in the third switch array 550C are arranged such that the output of each switch is connected to the same third analog output line 554C for connecting a selected one of the plurality of analog inputs 552B to a third control electrode 506C of a symmetric pair of control electrodes. The switches in the fourth switch array 550D are arranged such that the output of each switch is connected to the same fourth analog output line 554D for connecting a selected one of the plurality of analog inputs 552B to a fourth control electrode 506D of a symmetric pair of control electrodes. Each of the switches in the third and fourth switch arrays 550C, 550D has a switch activation line for causing the corresponding switch to close.

The second voltage control subcircuit 540B comprises a second latch 542B. The second latch 542B has eight inputs and eight outputs. The eight inputs comprise a third subset 544C and a fourth subset 544D, and the eight outputs comprise a third subset 546C and a fourth subset 546D. The second latch 542B has a latch enable line 548B.

Four of the bits from the 8-bit data bus 524 are connected to corresponding ones of the third subset 544C of second latch inputs, and the other four of the bits from the 8-bit data bus 524 are connected to corresponding ones of the fourth subset 544D of first latch inputs.

Each of the third subset 546C of second latch outputs is connected to a corresponding switch activation line of a corresponding switch in the third switch array 550C, and each of the fourth subset 546D of second latch outputs is connected to a corresponding switch activation line of a corresponding switch in the fourth switch array 550D.

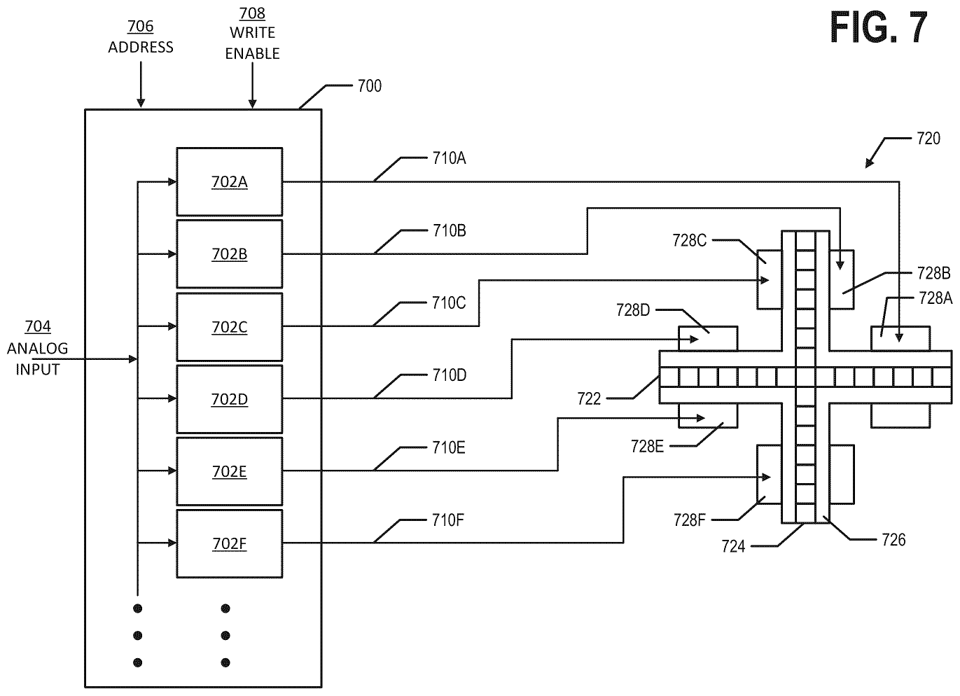

Referring now to FIG. 7, a schematic diagram of a switch network for voltage control on shim electrodes is provided in accordance with an example embodiment.

According to various embodiments, FIG. 7 illustrates a switch network 700 that provides voltage to shim electrodes of a quantum object confinement apparatus 720. The quantum object confinement apparatus 720 is identical to the quantum object confinement apparatus 500 of FIG. 5 in that the quantum object confinement apparatus 720 comprises a plurality of control electrodes 722 aligned along an x-axis, a plurality of control electrodes 724 aligned along a y-axis, RF bus electrodes 726 disposed about at least a portion of a perimeter zone of the atomic object confinement apparatus, and a plurality of shim electrodes 728A-F. Although not illustrated, as described above in relation to FIG. 4A, one or more of the shim electrodes 728A-F may be connected to an associated capacitor to hold the voltage on the shim electrode when the voltage source is disconnected from the shim electrode.

The switch network 700 of FIG. 7 comprises a plurality of switches 702A-F (the three dots indicate that the plurality of switches could include additional switches). Each switch 702A-F has an input that is connected to an analog input line 704 for receiving a voltage and an output that is connected to a respective output line 710A-F. Each output line 710A-F is also connected to a respective one of the plurality of shim electrodes 728A-F or to a capacitor connected to a respective one of the plurality of shim electrodes. The switch network 700 comprises an address line 706 for receiving a signal indicating which one of the plurality of switches 702A-F is to be closed to charge the corresponding shim electrode 728A-F. The switch network 700 comprises a write enable line 708 for receiving a signal to close the one of the plurality of switches 702A-F indicated by the signal received on the address line 706.

Shim electrodes have voltages that are fairly static compared to the control electrodes. The switch network of various embodiments of the present disclosure charges and re-charges the shim electrodes in a sequential or round robin manner. Instead of having a separate voltage source for each shim electrode, the switch network of various embodiments of the present disclosure enables a single voltage source to charge many different shim electrodes (perhaps hundreds or even thousands).

In operation, to charge the first shim electrode 728A, the address of the first switch 702A is written to the address line 706. A signal is applied to the write enable line 708 to close the first switch 702A (i.e., the switch indicated by the signal applied to the address line 706). A voltage (e.g., five volts) is applied to the analog input line 704. This voltage would be conducted to and charge the first shim electrode 728A. The signal would then be removed from the write enable line 708 and the first switch 702A would close. The first shim electrode 728A (or its associated capacitor) would hold that voltage for some period of time.

To charge the next, second shim electrode 728B, the address of the second switch 702B is written to the address line 706. A signal is applied to the write enable line 708 to close the second switch 702B (i.e., the switch indicated by the signal applied to the address line 706). A voltage (e.g., five volts) is applied to the analog input line 704. This voltage would be conducted to and charge the second shim electrode 728B. The signal would then be removed from the write enable line 708 and the second switch 702B would close. The second shim electrode 728B (or its associated capacitor) would hold that voltage for some period of time.

In various embodiments, these steps are repeated for all of the shim electrodes connected to the switch network. By the time all of the shim electrodes have been charged/recharges, it is possible that the voltage on one or more of the shim electrodes (especially the ones for which more time has passed since charging) may have decayed due to some parasitic resistance that is leaking some of the charge stored on the capacitor. Thus, in various embodiments the process is repeated to recharge all of the shim electrodes during quantum operations. In various embodiments, the process is repeated at constant intervals.

In various embodiments, the shim electrodes may be charged sequentially in a fixed order (e.g., first shim electrode first, second shim electrode second, third shim electrode third, etc.), or the shim electrodes may be charged in any suitable order. In various embodiments, the voltage applied to each shim electrode may be the same, or different voltages may be applied to one or more of the shim electrodes.

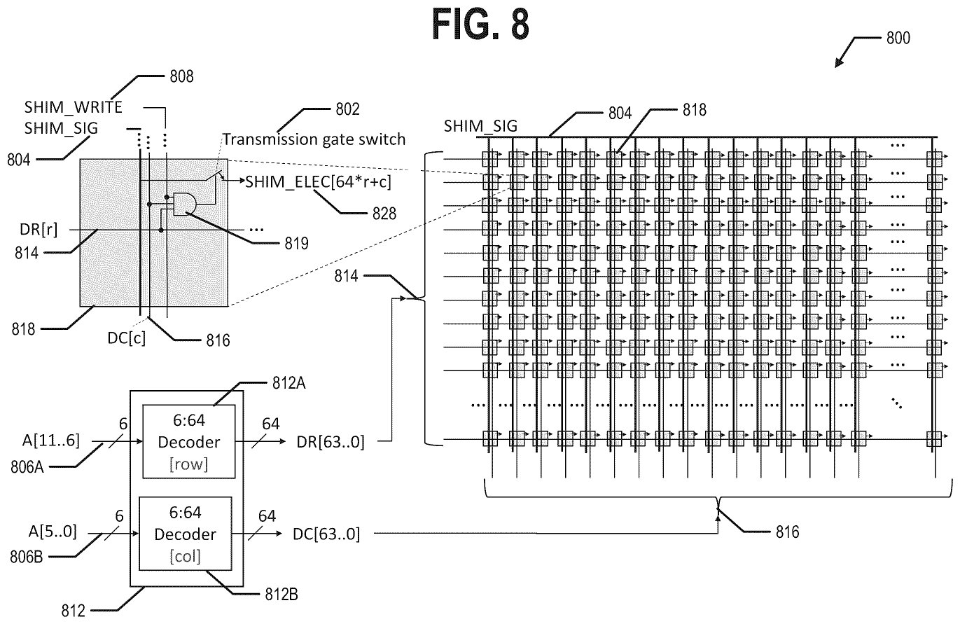

Referring now to FIG. 8, a schematic diagram of a switch network for voltage control on shim electrodes is provided in accordance with another example embodiment. According to various embodiments, FIG. 8 illustrates a switch network 800 that provides a voltage to shim electrodes of a quantum object confinement apparatus (not illustrated).

The switch network 800 of FIG. 8 comprises a plurality of switch assemblies 818 arranged in an array. Each of the switch assemblies 818 in the array is associated with and connected to a respective shim electrode (typically via a respective capacitor). The embodiment illustrated in FIG. 8 has a 64×64 array of switch assemblies 818, although any suitable number and arrangement may be used. A 64×64 array of switch assemblies 818 provides a total of 4096 switch assemblies, such that the voltage may be controlled for as many as 4096 shim electrodes in the illustrated embodiment.

One of the switch assemblies 818 is illustrated in more detail on the upper left side of FIG. 8. Each of the switch assemblies 818 comprises a switch 802 and one or more logic gates 819 (a 3-input AND gate is illustrated; however, any suitable gate or combination of gates may be used, e.g., one or more AND gates and/or one or more NAND gates) that control the activation of the switch 802 (as described further below).

The input of each switch 802 in all of the switch assemblies 818 is connected to a same analog input line 804 (also labeled SHIM_SIG) and the output of each switch 802 in all of the switch assemblies 818 is connected to a respective shim electrode 828 (also labeled SHIM_ELEC), thereby providing the desired voltage to the respective shim electrode when the respective switch is closed. The logic gate 819 in all of the switch assemblies 818 are connected to a same enable line 808 (also labeled SHIM_WRITE). The logic gate 819 in all of the switch assemblies 818 are also connected to a respective one of a plurality of decoder row outputs 814 (also labeled as DR(r)) and to a respective one of a plurality of decoder column outputs 816 (also labeled as DC(c)) (as described further below). The output of the logic gate 819 is connected to the enable input of its respective switch 802.

A decoder 812 specifies which switch 802 in the array of switch assemblies 818 is closed, based on a received address, such that the voltage on the analog input line 804 is provided to the respective shim electrode. The decoder 812 comprises a row decoder portion 812A and a column decoder portion 812B. In the illustrated embodiment, a 12-bit address is received, which comprises a 6-bit row address 806A (specifying, in the illustrated embodiment, one of the 64 rows) and a 6-bit column address 806B (specifying, in the illustrated embodiment, one of the 64 columns).

In operation, to charge a capacitor associated with a first shim electrode, the row address 806A and the column address 806B corresponding to the row and column location of the switch assembly associated with the first shim electrode are provided to the decoder 812, and the corresponding row output 814 and column output 816 are activated. The desired voltage to be provided to the first shim electrode is applied to the analog input line 804, and the enable line 808 is activated. In the switch assembly 818 corresponding to the first shim electrode, the row output 814, the column output 816, and the enable line 808 going to the logic gate 819 are all high, so the output of the logic gate 819 is high and the corresponding switch 802 closes and the voltage on the analog input line 804 is provided to the first shim electrode.

After a predetermined period of time to charge the capacitor associated with the first shim electrode, the enable line 808 is de-activated and the provided voltage is stored on the capacitor. To charge a capacitor associated with the next shim electrode, the row address 806A and the column address 806B corresponding to the row and column location of the switch assembly associated with the next shim electrode in the array are provided to the decoder 812 and the process repeats.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A quantum object confinement apparatus comprising:
one or more electrode sequences, each electrode sequence comprising a respective plurality of control electrodes configured to control an electric potential in a respective trapping region of one or more trapping regions of the quantum object confinement apparatus; and
a voltage control circuit for providing analog control signals to at least a first symmetric pair of the plurality of control electrodes, the first symmetric pair of the control electrodes comprising first and second symmetric control electrodes;
wherein the voltage control circuit (i) selectively closes one of a first plurality of switches to complete an electrical connection between the voltage control circuit and the first symmetric control electrode and (ii) simultaneously selectively closes one of a second plurality of switches to complete an electrical connection between the voltage control circuit and the second symmetric control electrode;
wherein the voltage control circuit applies a same voltage to an input of the one of the first plurality of switches and to an input of the one of the second plurality of switches prior to selectively closing the one of the first plurality of switches and the one of the second plurality of switches and as the one of the first plurality of switches and the one of the second plurality of switches close;
wherein the voltage control circuit selectively provides one of two or more analog control signals to the first symmetric control electrode via the one of the first plurality of switches after the one of the first plurality of switches is closed; and
wherein the voltage control circuit selectively provides one of two or more analog control signals to the second symmetric control electrode the one of the second plurality of switches after the one of the second plurality of switches is closed.

2. The quantum object confinement apparatus of claim 1, wherein the voltage control circuit comprises a first voltage control subcircuit for providing analog control signals to the first symmetric pair of the control electrodes, the first voltage control subcircuit comprising:
the first plurality of switches, each switch of the first plurality of switches having an input connected to a respective one of a first plurality of analog inputs, an output connected to a first analog output line for connecting a selected one of the first plurality of analog inputs to the first symmetric control electrode, and a switch activation line for causing a respective switch of the first plurality of switches to close;
the second plurality of switches, each switch of the second plurality of switches having an input connected to a respective one of the first plurality of analog inputs, an output connected to a second analog output line for connecting a selected one of the first plurality of analog inputs to the second symmetric control electrode, and a switch activation line for causing a respective switch of the second plurality of switches to close; and
first latching circuitry having a plurality of first latch inputs comprising first and second subsets of the first latch inputs, a corresponding plurality of first latch outputs comprising first and second subsets of the first latch outputs, and a first latch enable input, each one of the first subset of the first latch outputs connected to a switch activation line of a respective switch of the first plurality of switches, each one of the second subset of the first latch outputs connected to a switch activation line of a respective switch of the second plurality of switches; and
wherein applying a voltage to the first latch enable input causes (i) a voltage applied to one of the first subset of the first latch inputs to be present on a respective one of the first subset of the first latch outputs and therefore present on a respective one of the switch activation lines of the first plurality of switches, and (ii) a voltage applied to one of the second subset of the first latch inputs to be present on a respective one of the second subset of the first latch outputs and therefore present on a respective one of the switch activation lines of the second plurality of switches, thereby causing a respective one the first plurality of switches and a respective one of the second plurality of switches to close simultaneously.

3. The quantum object confinement apparatus of claim 2, wherein the voltage control circuit comprises a second voltage control subcircuit for providing analog control signals to a second symmetric pair of the control electrodes, the second symmetric pair of the control electrodes comprising third and fourth symmetric control electrodes, the second voltage control subcircuit comprising:
a third plurality of switches, each switch of the third plurality of switches having an input connected to a respective one of a second plurality of analog inputs, an output connected to a third analog output line for connecting a selected one of the second plurality of analog inputs to the third symmetric control electrode, and a switch activation line for causing the respective switch of the third plurality of switches to close;
a fourth plurality of switches, each switch of the fourth plurality of switches having an input connected to a respective one of the second plurality of analog inputs, an output connected to a fourth analog output line for connecting a selected one of the second plurality of analog inputs to the fourth symmetric control electrode, and a switch activation line for causing the respective switch of the fourth plurality of switches to close; and
second latching circuitry having a plurality of second latch inputs comprising first and second subsets of the second latch inputs, a corresponding plurality of second latch outputs comprising first and second subsets of the second latch outputs, and a second latch enable input, each one of the first subset of the second latch outputs connected to a switch activation line of a respective switch of the third plurality of switches, each one of the second subset of the second latch outputs connected to a switch activation line of a respective switch of the fourth plurality of switches; and
wherein applying a voltage to the second latch enable input causes (i) a voltage applied to one of the first subset of the second latch inputs to be present on a respective one of the first subset of the second latch outputs and therefore present on a respective one of the switch activation lines of the third plurality of switches, and (ii) a voltage applied to one of the second subset of the second latch inputs to be present on a respective one of the second subset of the second latch outputs and therefore present on a respective one of the switch activation lines of the fourth plurality of switches, thereby causing a respective one of the third plurality of switches and a respective one of the fourth plurality of switches to close simultaneously.

4. The quantum object confinement apparatus of claim 3, further comprising:
one or more data input lines for applying a voltage to one of the first subset of first latch inputs, one of the second subset of first latch inputs, one of the first subset of second latch inputs, and/or one of the second subset of second latch inputs; and
an address decoder comprising:
a plurality of latch enable outputs including a first latch enable output connected to a first latch enable input of the first latching circuitry and a second latch enable output connected to a second latch enable input of the second latching circuitry;
one or more address input lines for receiving an indication of which one or more of the plurality of latch enable outputs should be activated; and
an enable input for receiving an indication to activate the one or more of the plurality of latch enable outputs indicated by the one or more address input lines.

5. A quantum computer comprising:
two or more switchable control voltage sources each configured to generate a respective switchable control voltage signal;
a controller configured to control operation of each of the two or more switchable control voltage sources, and with which of the two or more switchable control voltage sources one or more switchable control electrodes are respectively in electrical communication; and
a quantum object confinement apparatus comprising:
one or more electrode sequences, each electrode sequence comprising a respective plurality of control electrodes configured to control an electric potential in a respective trapping region of one or more trapping regions of the quantum object confinement apparatus; and
a voltage control circuit for providing analog control signals to at least a first symmetric pair of the plurality of control electrodes, the first symmetric pair of the control electrodes comprising first and second symmetric control electrodes;
wherein the voltage control circuit (i) selectively closes one of a first plurality of switches to complete an electrical connection between the voltage control circuit and the first symmetric control electrode and (ii) simultaneously selectively closes one of a second plurality of switches to complete an electrical connection between the voltage control circuit and the second symmetric control electrode;
wherein the voltage control circuit applies a same voltage to an input of the one of the first plurality of switches and to an input of the one of the second plurality of switches prior to selectively closing the one of the first plurality of switches and the one of the second plurality of switches and as the one of the first plurality of switches and the one of the second plurality of switches close;
wherein the voltage control circuit selectively provides one of two or more analog control signals to the first symmetric control electrode via the one of the first plurality of switches after the one of the first plurality of switches is closed; and
wherein the voltage control circuit selectively provides one of two or more analog control signals to the second symmetric control electrode the one of the second plurality of switches after the one of the second plurality of switches is closed.

6. The quantum computer of claim 5, wherein the voltage control circuit comprises a first voltage control subcircuit for providing analog control signals to the first symmetric pair of the control electrodes, the first voltage control subcircuit comprising:
the first plurality of switches, each switch of the first plurality of switches having an input connected to a respective one of a first plurality of analog inputs, an output connected to a first analog output line for connecting a selected one of the first plurality of analog inputs to the first symmetric control electrode, and a switch activation line for causing a respective switch of the first plurality of switches to close;
the second plurality of switches, each switch of the second plurality of switches having an input connected to a respective one of the first plurality of analog inputs, an output connected to a second analog output line for connecting a selected one of the first plurality of analog inputs to the second symmetric control electrode, and a switch activation line for causing a respective switch of the second plurality of switches to close; and
first latching circuitry having a plurality of first latch inputs comprising first and second subsets of the first latch inputs, a corresponding plurality of first latch outputs comprising first and second subsets of the first latch outputs, and a first latch enable input, each one of the first subset of the first latch outputs connected to a switch activation line of a respective switch of the first plurality of switches, each one of the second subset of the first latch outputs connected to a switch activation line of a respective switch of the second plurality of switches; and
wherein applying a voltage to the first latch enable input causes (i) a voltage applied to one of the first subset of the first latch inputs to be present on a respective one of the first subset of the first latch outputs and therefore present on a respective one of the switch activation lines of the first plurality of switches, and (ii) a voltage applied to one of the second subset of the first latch inputs to be present on a respective one of the second subset of the first latch outputs and therefore present on a respective one of the switch activation lines of the second plurality of switches, thereby causing a respective one the first plurality of switches and a respective one of the second plurality of switches to close simultaneously.

7. The quantum computer of claim 6, wherein the voltage control circuit comprises a second voltage control subcircuit for providing analog control signals to a second symmetric pair of the control electrodes, the second symmetric pair of the control electrodes comprising third and fourth symmetric control electrodes, the second voltage control subcircuit comprising:
a third plurality of switches, each switch of the third plurality of switches having an input connected to a respective one of a second plurality of analog inputs, an output connected to a third analog output line for connecting a selected one of the second plurality of analog inputs to the third symmetric control electrode, and a switch activation line for causing the respective switch of the third plurality of switches to close;
a fourth plurality of switches, each switch of the fourth plurality of switches having an input connected to a respective one of the second plurality of analog inputs, an output connected to a fourth analog output line for connecting a selected one of the second plurality of analog inputs to the fourth symmetric control electrode, and a switch activation line for causing the respective switch of the fourth plurality of switches to close; and
second latching circuitry having a plurality of second latch inputs comprising first and second subsets of the second latch inputs, a corresponding plurality of second latch outputs comprising first and second subsets of the second latch outputs, and a second latch enable input, each one of the first subset of the second latch outputs connected to a switch activation line of a respective switch of the third plurality of switches, each one of the second subset of the second latch outputs connected to a switch activation line of a respective switch of the fourth plurality of switches; and
wherein applying a voltage to the second latch enable input causes (i) a voltage applied to one of the first subset of the second latch inputs to be present on a respective one of the first subset of the second latch outputs and therefore present on a respective one of the switch activation lines of the third plurality of switches, and (ii) a voltage applied to one of the second subset of the second latch inputs to be present on a respective one of the second subset of the second latch outputs and therefore present on a respective one of the switch activation lines of the fourth plurality of switches, thereby causing a respective one of the third plurality of switches and a respective one of the fourth plurality of switches to close simultaneously.

8. The quantum computer of claim 7, where the quantum object confinement apparatus further comprises:
one or more data input lines for applying a voltage to one of the first subset of first latch inputs, one of the second subset of first latch inputs, one of the first subset of second latch inputs, and/or one of the second subset of second latch inputs; and
an address decoder comprising:
a plurality of latch enable outputs including a first latch enable output connected to a first latch enable input of the first latching circuitry and a second latch enable output connected to a second latch enable input of the second latching circuitry;
one or more address input lines for receiving an indication of which one or more of the plurality of latch enable outputs should be activated; and
an enable input for receiving an indication to activate the one or more of the plurality of latch enable outputs indicated by the one or more address input lines.

9. A quantum object confinement apparatus comprising:
a plurality of electrode sequences, each electrode sequence comprising a respective plurality of control electrodes configured to control an electric potential in a respective trapping region of one or more trapping regions of the quantum object confinement apparatus and a plurality of shim electrodes configured to compensate for stray fields in a respective trapping region;
a switching device comprising:
an analog input line for receiving a voltage;
a plurality of switches, each switch having an input connected to the analog input line and an output connected to a respective output line which is also connected to a respective one of the plurality of shim electrodes and/or to a capacitor connected to a respective one of the plurality of shim electrodes;
an address line for receiving a signal indicating which one of the plurality of switches is to be closed; and
a write enable line for receiving a signal to close the one of the plurality of switches indicated by the signal received by the address line; and
a controller for (i) providing an address to the address line to select a first one of the plurality of switches, (ii) providing a first voltage to the analog input line, (iii) providing a signal to the write enable line to cause the first one of the plurality of switches to close to apply the first voltage to a first shim electrode and/or to a capacitor connected to the first shim electrode, and (iv) removing the signal to the write enable line to cause the first one of the plurality of switches to open;
wherein the controller repeats steps (i), (ii), (iii), and (iv) for each of a remaining plurality of switches and a remaining plurality of shim electrodes.

10. The quantum object confinement apparatus of claim 9, wherein a same voltage is applied to each of the plurality of shim electrodes and/or to a capacitor connected to each of the plurality of shim electrodes.
